(19) United States
(12) Patent Application Publication
(10) Pub. No.: US 2013/0196106 A1
(43) Pub. Date: Aug. 1, 2013

(54) ADHESIVE PRODUCTS IN SHEET FORM

(71) Applicant: Duonne Erasmus, Hilton (ZA)

(72) Inventor: Duonne Erasmus, Hilton (ZA)

(73) Assignee: InstaFibre Ltd, Wokingham Berkshire (GB)

(21) Appl. No.: 13/811,116

(22) PCT Filed: Jul. 19, 2011
(86) PCT No.: PCT/GB2011/001080

§ 371 Date: Mar. 22, 2013

(30) Foreign Application Priority Data
Jul. 19, 2010 (GB) 1012088.9
Jul. 19, 2010 (GB) 1012089.7

(51) Int. Cl. C09J 7/04; G01N 19/04

(52) U.S. Cl. CPC C09J 7/04; G01N 19/04
USPC 428/41.8; 442/1; 156/242; 73/150 A

(57) ABSTRACT

A product, generally in sheet form, allowing adjustment in positioning on installation and subsequent removal, the product comprises: a layer comprising crumb-rubber material, and having a first side and a second side. Scrim material is bonded to at least one of the first and second sides. A coating of a low-grab pressure sensitive adhesive is applied to at least part of the exposed surface of the scrim material. The adhesive is determined to be a low-grab adhesive if, after 24 hours adhesive binding dwell-time, a 90° peel adhesion at 300 mm/minute, as measured by the FINAT Test Method No: 2, of between 1.77 and 3.96 Newtons/25 mm width at room temperature (23° C.±1° C.) and at a relative humidity of 50%±5%.

### BACKGROUND

This disclosure relates to adhesive products in sheet form. In particular, but not exclusively, it relates to adhesive products in sheet form suitable for use as underlays, for example for floor coverings.

Crumb-rubber underlays in which the crumbs are bonded to each other and to a supporting scrim layer on at least one side have been used as general purpose flooring underlays for over 40 years as they have a number of inherent properties that make them especially useful for the higher end of the market, namely:
relatively high mass per unit volume (density), which produces a material that has a high “flop-weight”;
highly efficient acoustic insulation properties as a consequence of its relatively high density;
the crumb-rubber particles, which make up 80-90% of the volume of the product, consist of vulcanised rubber and therefore cannot collapse over time;
an open-cell structure resulting from bonding of the rubber granules to one another during manufacture of the product using a synthetic rubber binder;
during compression of the product, the vulcanised rubber granules compress and then immediately rebound to their original shape once the pressure is released, so that the product always returns to its original shape and thickness after compression, regardless of the extent or duration of that compression;
as compared with a solid rubber sheet, the flexible open-cell structure allows the product to be compressed relatively easily when subjected to a point load, and yet provides a firm, non-collapsing surface when subject to a distributed load;
the open-cell structure allows air to flow freely through the material, making the product more “breathable” and more hygienic at the microbial level;
the open-cell structure allows heat transfer through air circulation, but still has relatively good thermal insulation properties;
the product can be flooded and then dried in situ without altering performance or causing odours; and
exposed rubber granules form a surface that results in enhanced grip on most surfaces with which it comes into contact.

Despite these known properties and this long period of use, it appears that it was not until 2008 that any proposal was made for a crumb-rubber underlay with a scrim material layer on at least one side to be provided with a coating of a pressure sensitive adhesive. Just such an underlay is proposed in ZA 2008/04310 of Rubber Lay (Pty) Ltd. No specific adhesive, nor any properties for such adhesive are suggested in ZA 2008/04310, save that the adhesive may be a pressure sensitive adhesive and may be directly applied or applied over a first coating of amorphous, high temperature, hot melt adhesive. The adhesive was disclosed in ZA 2008/04310 as being protected by a silicone release paper that could be removed by a floor-covering installer to expose the adhesive to allow the underside of the floor covering to be adhered to the exposed adhesive of the underlay.

It appears that this underlay may not have been a commercial success since Rubber Lay (Pty) Ltd went into voluntary liquidation in February 2009, only small sample volumes of their crumb-rubber underlay product having ever been produced.

The problem, glossed over in ZA 2008/04310, lies in the choice of adhesive. As will become clear from the detailed disclosure below, this problem had not been adequately solved by any specific product of Rubber Lay (Pty) Ltd. The present disclosure, which may be regarded as a selection from the broad disclosure of ZA 2008/04310, provides a solution to that problem. Reference may also be made to British Patent Application No: 1012088.9 (M.J.P. Deans Reference No: P10748 GB), filed on the same date as British Patent Application No: 1012089.7 from which the present application claims priority and to our copending British Patent Application No: (M.J.P. Deans Reference No: P10820 GB) filed the same day as this application, which disclose an alternative and different solution to the problem.

Our analysis of potential applications for underlays, both traditional flooring underlays and other applications by extension, established that there was a need for two distinct types of underlay, namely those that call for high adhesive strength (hereafter: “high-grab”) for best results, and those that call for significantly lower adhesive strength (hereafter: “low-grab”) for best results.

Reference may be made to Table 1 below which, in addition to distinguishing between high-grab and low-grab for use with different flooring products, also identifies whether a 3 mm or 5 mm flat product or a 6 mm ribbed product gives best results.

TABLE 1

| | Low Grab Products | | | High Grab Products | | |
|---|---|---|---|---|---|---|
| Installation Types by Market | 3 mm | 5 mm | 6 mm | 3 mm | 5 mm | 6 mm |
| Segment | Flat | Flat | Ribbed | Flat | Flat | Ribbed |
| Commercial Segment | | | | | | |
| Carpet (wheeled Traffic) | | | | | | |
| Woven Broadloom (double stick) | | | | * | * | |
| Tufted Broadloom (double stick) | | | | * | * | |
| Tufted Tiles (double stick, no | | | | * | * | |
| replacement) | | | | | | |
| Needlepunch Broadloom (double stick) | | | | * | * | |
| Carpet (med/low traffic) | | | | | | |
| Woven Broadloom (single stick) | | | | * | * | * |
| Woven Broadloom (double stick) | | | | * | * | |
| Tufted Broadloom (single stick) | | | | * | * | * |
| Tufted Broadloom (double stick) | | | | * | * | |
| Tufted Tiles (double stick, | * | * | | | | |
| replacement) | | | | | | |
| Tufted Tiles (double stick, no | | | | * | * | |
| replacement) | | | | | | |
| Needlepunch Broadloom (single stick) | | | | | * | |
| Needlepunch Broadloom (double stick) | | | | * | * | |
| Needlepunch carpet tiles- | | | | | | |
| replacement required | | | | | | |
| Needlepunch tiles (backed, single | * | * | | | | |
| stick/double stick) | | | | | | |
| Needlepunch tiles - no replacement | | | | | | |
| Needlepunch tiles (backed/unbacked, | | | | * | * | |
| single/double stick) | | | | | | |
| Residential & DIY Segments | | | | | | |
| Carpet | | | | | | |
| Woven & Tufted Broadloom (single | | | | * | * | * |
| stick) | | | | | | |
| Tufted tiles | * | * | | * | * | |
| Needlepunch Broadloom (single stick) | | | | | * | |
| Needlepunch Broadloom (double stick) | | | | * | * | |
| Needlepunch Tiles (backed, | * | * | | | | |
| single/double stick, replacement) | | | | | | |
| Needlepunch Tiles (unbacked, | | | | * | * | |
| single/double stick) | | | | | | |
| Commercial, Residential & DIY | | | | | | |
| Segments | | | | | | |
| Wood (all single stick) | | | | | | |
| Tongue & Groove Solid floating | | | | * | * | |
| Tongue & Groove Engineered floating | | | | * | * | |
| Double-click Engineered floating | * | * | | | | |
| Laminate | * | * | | | | |
| Vinyl | | | | | | |
| Sheeting (double stick) | | | | * | | |
| Loose Rugs (non-slip, removable | * | | | | | |
| underlay) | | | | | | |

### SUMMARY

In accordance with a first aspect of the present disclosure, there is provided a product, generally in sheet form, allowing adjustment in positioning on installation and subsequent removal, the product comprising: a layer comprising crumb-rubber material, and having a first side and a second side; scrim material bonded to at least one of said first and second sides; and a coating of a low-grab pressure sensitive adhesive applied to at least part of the exposed surface of the scrim material; a low-grab adhesive being defined as an adhesive having, after 24 hours adhesive binding dwell-time, a 90° peel adhesion at 300 mm/minute, as measured by the FINAT Test Method No: 2, of between 1.77 and 3.96 Newtons/25 mm width at room temperature (23° C.±1° C.) and at a relative humidity of 50%±5%.

Preferred embodiments may have one or more of the following features: The product is an underlay for a floor covering. Alternatively the product is formed as a slip-resisting material to be adhered to the base of a sofa or to the underside of a loose cushion to resist movement on upholstered furniture or to be adhered to the underside of a rug. In yet another alternative, the product is formed as a removable mat or flooring for a motor vehicle for use on the floor of the seating compartment or on the floor of the boot (trunk), the adhesive holding the mat/flooring in place but allowing it to be removed for cleaning, and the crumb-rubber surface providing slip resistance, as well as cushioning for objects, for example luggage, placed on the mat/flooring. The crumb-rubber material suitably comprises individual crumbs of rubber bonded together by a bonding agent. A removable silicone-coated release sheet is adhered to the exposed adhesive surface.

### BRIEF DESCRIPTION OF THE DRAWINGS

Embodiments of adhesive product in accordance with the teachings of this disclosure are described in more detail hereinbelow by way of example only with reference to the accompanying drawings, in which:

FIG. 1 shows a somewhat schematic perspective side elevation of a portion of a first embodiment of underlay;

FIG. 2 shows a similarly schematic side elevation of a portion of a second embodiment of underlay;

FIG. 3 shows a similarly schematic side elevation of a portion of a third embodiment of underlay;

FIG. 4 shows a diagram illustrating a peel adhesion test employing the FINAT Test Method No: 2; and

FIG. 5 is a graph showing peel adhesion test results for test samples of adhesive applied at different coat weights, and for a comparative sample, in each case after 24 hours adhesive binding dwell-time.

### DESCRIPTION OF PREFERRED EMBODIMENTS

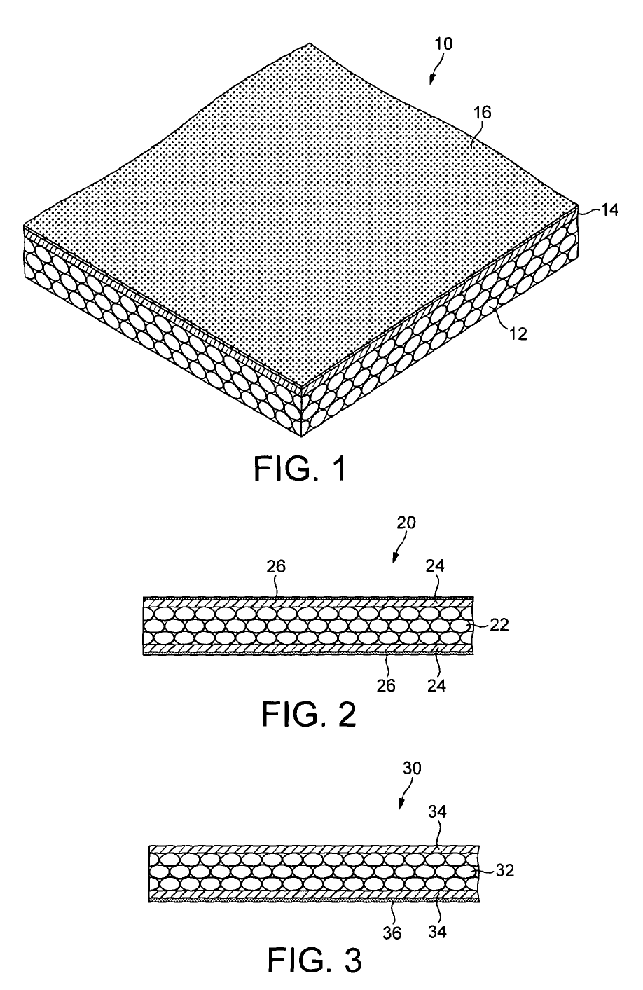

Referring first to FIG. 1, a generally sheet form underlay 10 includes a crumb-rubber layer 12 with scrim material 14 bonded to a first surface of the crumb-rubber layer. It will be understood that, in practice, the individual crumbs of the crumb-rubber layer will not be uniform in size or exclusively oval in section. Crumb rubber underlays bonded to scrim are well known, as are their manufacturing techniques, and so only a brief description is deemed necessary here. The scrim is bonded to the rubber crumbs and the crumbs to each other at the same time. The “wet” crumb-rubber compound (that is: including a synthetic rubber latex or natural rubber binder) is laid onto the scrim prior to moving under a doctor blade which skims the wet compound to the correct thickness. The scrim then carries the wet compound through the curing oven and, as the binder sets, it binds the crumb rubber particles to one another and, at the same time, to the scrim which is carrying the compound through the curing stenter oven. The thickness of the rubber layer is suitably between 2 mm and 15 mm. Preferred thicknesses for different forms of flooring are set out in Table 1 above, but other thicknesses within the above range may be used. For example, an 8 mm product would show enhanced acoustic performance. The rubber layer may be flat with a uniform thickness across both width and length of the underlay, as shown in FIG. 1, or may be undulating with a corrugated profile on its second side, as in the 6 mm ribbed version referred to in Table 1. In the particular embodiment illustrated in FIG. 1, a low-grab adhesive 16, as defined herein and explained in more detail below, is applied evenly to the surface of the scrim material 14. The adhesive could equally well be applied in a pattern of spots or as uniform bands or overlapping swirl-spray strands across the surface of scrim material 14. The adhesive may additionally be applied to the rubber surface.

The scrim material may be chosen from different weights of non-woven polypropylene, woven polypropylene, woven poly-jute, namely a combination of woven polypropylene and jute, jute, fiberglass reinforced cellulose, woven fiberglass, non-woven fiberglass, woven polyester, non-woven polyester, or of stitch bonded crepe paper, but is typically a 30 g/m² or 60 g/m² non-woven polypropylene. For practical manufacturing considerations, we prefer the 60 g/m² non-woven polypropylene.

Although not illustrated, it will be understood that a release sheet, suitably a film coated with a silicone release layer, covers the adhesive to protect it, and is peeled off before adhering the underlay to a floor or floor covering surface by the adhesive 16.

FIG. 2 shows a similar underlay 20, which differs from that of FIG. 1 by having a crumb-rubber layer 22 with scrim material 24 bonded to both surfaces thereof, and with low-grab adhesive 26 applied to both scrim material layers. The embodiment of FIG. 3 is similar, with a crumb-rubber layer 32 having scrim material 34 bonded to both surfaces thereof, but has adhesive 36 applied to only one scrim material layer. Production of underlays with double scrim layers is similar to the process described above, the only difference being that the “wet” rubber crumb material is sandwiched between the two scrims which are bonded to the sandwiched material during the curing process in the stenter oven.

The low-grab adhesive 16, 26 or 36 is important for installation of the flooring types for which it is intended, in order to get superior results. The present underlays with their low-grab adhesives are employed where a degree of adjustment in placement of the underlay in the correct position is desired or where the flooring installation is likely to need to be lifted subsequently. Similar adhesive is employed for other embodiments of sheet-form adhesive product for adhesion to cushions, couches, the boots (trunks) of motor vehicles, or loose mats as described further below, in each of which there may be a need for the sheet-form product to be removed subsequently without transferring adhesive to the substrate or causing damage on removal.

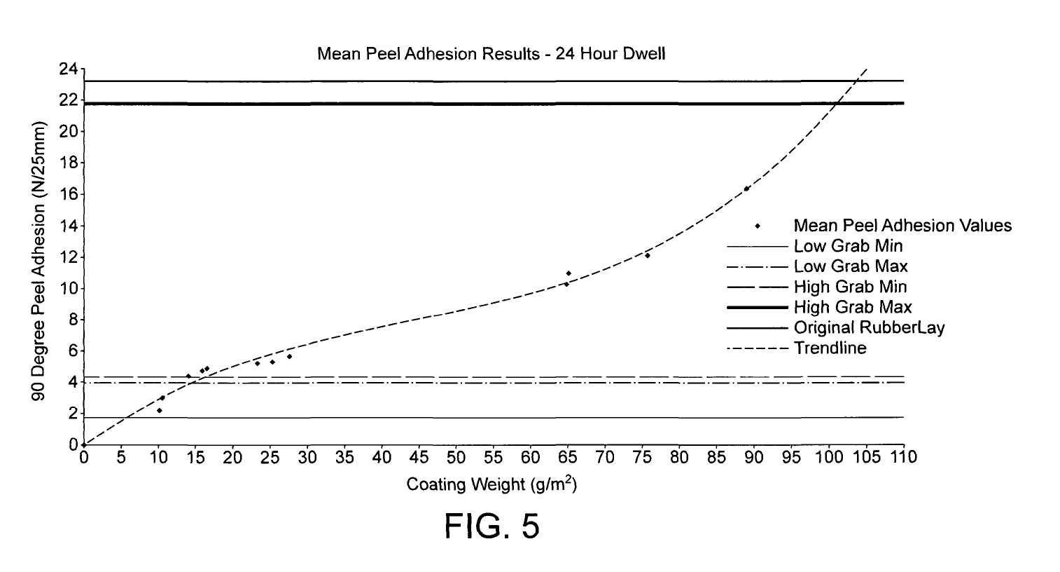

Tests for peel adhesion were performed with a number of samples using the FINAT Test Method No: 2 (as explained in more detail below). The results are set out in Table 2 (below) and FIG. 5.

Different adhesives show different characteristics, and we have established that neither choice of adhesive alone nor coat weight alone is an adequate indicator, but rather that peel adhesion is the only reliable measure of whether an adhesive present on a product in sheet form suitable for use as an underlay may be regarded as a high-grab adhesive or as a low-grab adhesive. As will be apparent from analysis of the test results explained below, the same adhesive may serve as a high-grab adhesive under some conditions and as a low-grab adhesive under others.

We achieved the test results shown in Table 2 and FIG. 5 using a commercially available adhesive, namely Unikem™ HPS 800 C, but other commercially available adhesives such as Henkel™ PD 1573 or Advanced Adhesives™ XM 2218 could equally well have been employed. The experimental data given in Table 2 and illustrated in graphical form in FIG. 5 is the mean of three replications at each coating weight of the adhesive. Peel adhesion was determined by the FINAT Test method No: 2 peel adhesion test performed after 24 hours adhesive binding dwell-time at room temperature (23° C.±1° C.) and at a relative humidity of 50%±5%, the temperature and humidity conditions of a typical laboratory. While the FINAT Test method No: 2 peel adhesion test performed after 20 minutes adhesive binding dwell-time, discussed in British Patent Application No: 1012089.7, can also produce results suggesting high-grab or low-grab characteristics, these results tend to be less reliable and less consistent than with the 24 hour adhesive binding dwell-time, and give spurious results with some coat weights, as a result of the much shorter adhesive binding dwell-time. Accordingly, we now much prefer the FINAT Test method No: 2 peel adhesion test after 24 hours adhesive binding dwell-time as a means of differentiating between high-grab, low-grab and neither. It is generally indicative of the final peel adhesion of practical underlays.

For the present tests, adhesive coating was achieved by using a Nordson™ BM200 Drum Melter in combination with a Nordson™ MX44160 Bulk Melter and a Nordson™ BC31-4/2100 Slot Nozzle Coating Head. In the Drum Melter a heated platen is forced down by two air cylinders on to a puddle of hot melt adhesive under the platen. The hot melt flows up into a positive displacement gear pump mounted on the platen and along a heated hose to the Bulk Melter, which has three main casting assemblies, namely hopper, grid and reservoir through which the hot melt passes. The reservoir has four positive displacement pumps at which the hot melt is forced through a filter and out into a heated hose to the Slot Nozzle Coating Head. A pressure transducer and pressure control valve is fitted in each pump outlet. The Slot Nozzle Coating Head has four shut-off valves to which the heated hoses are connected, and which control the flow of adhesive into the slot nozzle. They deliver the hot melt into the internal passages designed to ensure an even coating thickness across a width selected by a set of shims. The coating weight applied to a substrate, here the scrim overlying the crumb rubber layer, is determined in part by the rate at which the substrate passes the coating head and by the width over which the adhesive is applied. While the coat weight applied in a production run is much easier to determine, determination of the exact coat weight applied to a sample is more difficult. For different samples, coat weight may be varied by adjusting speed of movement of the sample through the machine. Thus, in order to produce a product, generally in sheet form, suitable for use as an underlay with low-grab characteristics, the manufacturing process should be varied by coat weight adjustment (which may be by speed of movement of the product through the coating machinery) until samples provide results by the FINAT Test method No: 2 peel adhesion test after 24 hours adhesive binding dwell-time within the limits prescribed above.

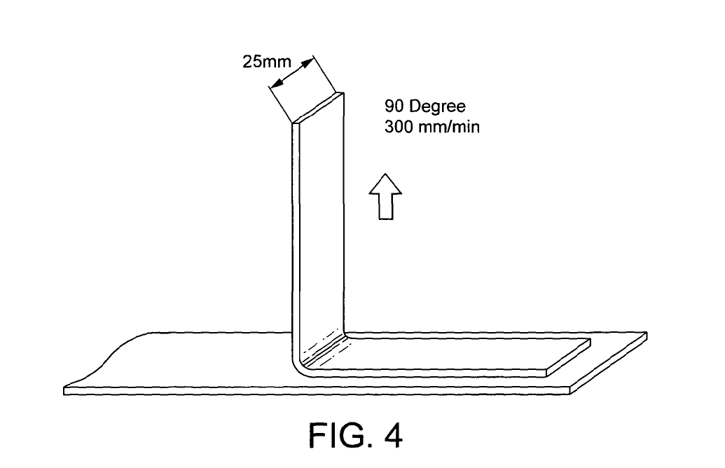

For details of peel adhesion testing by the FINAT Test Method No: 2, reference may be made to “FINAT Technical Handbook—Test Methods”, 8^{th} Edition, published by FINAT. This test provides an industry standard test for peel adhesion, which involves the use of test strips of rubber that are 25 mm wide and 200 mm long and are adhered to a glass substrate for an adhesive binding dwell-time of either 20 minutes or 24 hours and then pulled apart on a test rig at an angle of 90° by drawing an edge of the rubber strip perpendicularly away from the glass substrate at 300 mm/minute, and measuring the force required to achieve this, as indicated schematically in FIG. 4. A wide range of test equipment is commercially available from different manufacturers to carry out these tests. The tests for the samples of Table 2 (below) and FIG. 5 were performed using a Cheminstruments™ AR-1500 Adhesion Release Tester. Another suitable tester is a JJ Lloyd LR 30K plus Tensometer. The tests were performed at room temperature (23° C.±1° C.) and at a relative humidity of 50%±5%, temperature and humidity conditions found in a typical test laboratory. The results after 24 hours of adhesive binding dwell-time are regarded as the ultimate values, which are unlikely to improve even after extended periods. For comparison, the same tests were performed using a sample of the original RubberLay™ material.

TABLE 2

| | Newtons/25 mm after | |
|---|---|---|
| | 24 Hours Adhesive | |
| | Binding Dwell Time at | |
| | Room Temperature | Coating Weight |
| Sample ID | (23° C. +/− 1° C.) | (g/m²) |
| Low Grab | 1.77 | |
| Minimum | | |
| 1 | 2.20 | 10.00 |
| 2 | 3.01 | 10.40 |
| Low Grab | 3.96 | |
| Maximum | | |
| High Grab | 4.35 | |
| Minimum | | |
| 3 | 4.40 | 13.97 |
| 4 | 4.46 | 14.00 |
| 5 | 4.75 | 15.84 |
| 6 | 4.89 | 16.44 |
| 7 | 5.23 | 23.20 |
| 8 | 5.33 | 25.20 |
| 9 | 5.68 | 27.52 |
| 10 | 10.27 | 64.92 |
| 11 | 10.96 | 65.20 |
| 12 | 12.09 | 75.84 |
| 13 | 16.37 | 89.20 |
| High Grab | 21.76 | |
| Maximum | | |
| Original RubberLay | 23.20 | |

FIG. 5 shows the same results graphically, with a “best fit” line drawn through the data points, to which a zero coat weight point has been added, given that zero coat weight will necessarily show zero peel adhesion. There are relatively few data points at low coat weights, as it is inherently technically difficult to apply low coating weights. Even so, it will be seen that the “best-fit” line is a relatively poor fit for the first few data points. In reality, at very low coat weights, there is virtually no adhesion. Then, at a threshold coat weight, which for this particular adhesive appears to be at around 10 g/m², the peel adhesion increases very rapidly with added coat weight, before leveling out with a peel adhesion of a little under 6 Newtons/25 mm at a coat weight of between 20 and 30 g/m² for this particular adhesive. At much higher coat weights, the rate of increase of peel adhesion with added coat weight again increases.

It transpires that it is in the region of rapid increase of peel adhesion with coat weight at lower coat weights, that the adhesive exhibits low-grab properties, while peel adhesions in the range of coat weights for which the peel adhesion levels off exhibit high-grab properties. This was established by carrying out test installations with samples of the coated underlay and different floor coverings.

We found that Sample IDs 1 and 2 allowed practical release from the floor covering. Carpet tiles could be removed from the underlay with their backing intact. Wood laminate could also be readily uplifted after installation, thereby enabling ready replacement of the floor covering. Similar release characteristics were found below rugs. The underlay could be removed from the rug and subsequently replaced. Thus Sample IDs 1 and 2 were characterized as low-grab.

However, when these same practical installation tests were repeated for Sample ID 3, when removing carpet tiles, some of the backing from the carpet tiles came away and remained on the underlay. When attempting to uplift a wood laminate, we found that it did not easily pull away. In some cases, the underlay was damaged when the laminate was removed. Accordingly, Sample ID 3 was not suitable for use where potential replacement of the floor covering may occur. It could not be characterized as a low-grab adhesive, and should be characterized as a high-grab adhesive at the lower end of the high-grab range.

Sample IDs 4 to 13 also exhibited high-grab characteristics.

The single sample of the original RubberLay™ material exhibited a very high peel adhesion significantly beyond that of any of our own test samples. It proved so fierce in practical installation tests that it provided no margin for any error during application, and so did not represent a practicable option even for installations requiring high-grab characteristics.

We have used the above test data to establish practical boundaries between low-grab and high-grab adhesives in terms of peel adhesion. Given that Sample ID 3 with a peel adhesion of 4.40 Newtons/25 mm had been established as exhibiting high-grab characteristics, while Sample ID 2 with a peel adhesion of 3.01 Newtons/25 mm worked well in installations that required a low-grab adhesive, we set the minimum boundary for high-grab adhesives at 1% below the Sample ID 3 level, namely at 4.35 Newtons/25 mm, and the maximum peel adhesion for low-grab characteristics at 10% below the Sample ID 3 level, namely at 3.96 Newtons/25 mm.

A minimum peel adhesion of 1.77 Newtons/25 mm for a low-grab adhesive is effectively set by the practical problems in applying adhesive at very low coat weights. We were able to produce a single sample having a coat weight of 3 g/m² that exhibited a peel adhesion of 1.01 Newtons/25 mm. When this single sample was tested in practical installations calling for low-grab characteristics, it did not perform well, as it provided insufficient adhesion. The floor covering tended to move after application to the underlay. A practical lower limit for peel adhesion for satisfactory results can be set by taking the midpoint between this single unsatisfactory sample and Sample ID 1, which was known to have satisfactory low-grab characteristics, and adding 10%.

A practical maximum for peel adhesion for practicable high-grab characteristics can be established from the fact that Sample ID 13 with a peel adhesion of 16.37 Newtons/25 mm performed well as a high-grab product, whereas the original RubberLay™ material exhibited a peel adhesion of 23.20 Newtons/25 mm but was too fierce to be practicable. Accordingly, we can set a practical upper limit for high-grab peel adhesion by taking the midpoint between these figures and adding 10%, resulting in a practical upper limit of 21.76 Newtons/25 mm.

The above figures for peel adhesion will determine practicable low-grab and high-grab products, regardless of the particular adhesive. Repeating the peel adhesion tests with a different adhesive, for example Henkel™ PD 1573 or Advanced Adhesives™ XM 2218, using samples having varying coat weights, would give a similar set of data points with a similar best-fit curve, but with the coat weights for the peel adhesion values required for low-grab and for high-grab being at different figures from those shown in Table 2 for Unikem™ HPS 800 C.

Thus, in order to produce an adhesive product, generally in sheet form, allowing adjustment in positioning on installation and subsequent removal, with a selected adhesive, whether one of those mentioned above or any other commercially available pressure sensitive adhesive, the manufacturing process should be varied by coat weight adjustment (which may be by speed of movement of the product through the coating machinery) until samples provide results by the FINAT Test method No: 2 peel adhesion test after 24 hours adhesive binding dwell-time that are within the limits for low-grab prescribed above.

A wide variety of adhesives are available on the market. A floor-covering contractor needing to fit a conventional underlay without any adhesive layer and a floor covering over the top of it, for example in a new office block or hotel, would likely have applied a selected adhesive to the underlying floor surface and/or between underlay and floor covering. The provision of an underlay with a pressure sensitive adhesive layer already present on the underlay, and that provides low-grab characteristics, represents a major departure from industry practice for flooring contractor use. It also opens up the possibility for the Do-it-Yourself market. The use of an underlay employing a low-grab adhesive is especially important where the underlay or floor covering might need to be lifted subsequently, for example for access to water and electricity services in or below the underlying floor, or for the replacement of soiled or worn carpeting or carpet tiles from time to time.

Although the above description with reference to FIGS. 1 to 3 is in terms of use only of low-grab adhesives, we also contemplate a double scrim product in which low-grab adhesive is applied to one scrim layer and a high-grab adhesive, with peel adhesion within the limits for high-grab prescribed above, is applied to the other scrim layer. In use of this embodiment, we contemplate that the low-grab adhesive side would be applied to the sub-floor, while the high-grab adhesive side would be adhered to the floor covering in a context where permanent adhesion of the floor covering is desired. Alternatively, this could be reversed, with the high-grab adhesive adhered to the sub-floor and the low-grab adhesive adhered to the floor covering, which would prove useful in circumstances where the floor covering may need to be replaced from time to time, as when individual carpet tiles become soiled and need to be moved to another location or replaced with new ones.

In alternative arrangements, there may be low-grab adhesive on a scrim layer on both sides of the crumb rubber layer, or there may be low-grab adhesive on a scrim layer on one side and either high-grab or low-grab adhesive applied directly to the crumb-rubber material on the other side.

The use of adhesive products generally in sheet form, as taught herein, is not restricted to use as underlays.

Thus, in one example, a sheet of slip-resisting material formed of crumb-rubber bonded to a scrim sheet is adhered to the back or to the underside of a loose cushion to resist movement on upholstered furniture. The low-grab adhesive is applied to the scrim material in exactly the same way as described above for underlays. The exposed crumb-rubber surface resists slippage against an underlying surface. A similar sheet may be applied to the underside of a rug in a similar fashion. Rather than employing a sheet covering the whole underside or back surface of a cushion or rug, the adhesive product may be applied in discrete patches.

The generally sheet-form adhesive product may be formed as a removable mat or flooring for a motor vehicle for use on the floor of the seating compartment or on the floor of the boot (trunk). The latter use has the advantages that the mat/flooring is held in place by the low-grab adhesive, but may be lifted for cleaning or replacement, while the exposed crumb-rubber surface, in addition to cushioning any load, provides a slip resisting surface for objects, for example luggage, placed on the mat/flooring.

1. A product, generally in sheet form, allowing adjustment in positioning on installation and subsequent removal, the product comprising:
a layer comprising crumb-rubber material, and having a first side and a second side;
scrim material bonded to at least one of said first and second sides; and
a coating of a low-grab pressure sensitive adhesive applied to at least part of an exposed surface of the scrim material,
wherein the low-grab adhesive comprises an adhesive having, after 24 hours adhesive binding dwell-time, a 90° peel adhesion at 300 mm/minute, as measured by FINAT Test Method No: 2, of between 1.77 and 3.96 Newtons/25 mm width at room temperature (23° C.±1° C.) and at a relative humidity of 50%±5%.

2. A product according to claim 1, wherein the crumb-rubber material comprises individual crumbs of rubber bonded together by a bonding agent.

3. A product according to claim 1, wherein a layer of the scrim material is bonded to each of said first and second sides and the low-grab adhesive is applied to at least part of an exposed surface of the scrim material on both sides of the product.

4. A product according to claim 1, further comprising a release sheet adhered to an exposed surface of the adhesive coating.

5. A product according to claim 1, wherein the product is adapted to be used as an underlay for a floor covering.

6. A product according to claim 1, wherein the product is adapted to be used as a slip-resisting material to be adhered to a base of a sofa or to an underside of a loose cushion to resist movement on upholstered furniture or to be adhered to an underside of a rug.

7. A product according to claim 1, wherein the product is adapted to be used as a removable mat or flooring for a motor vehicle for use on a floor of a seating compartment or on a floor of a trunk, the adhesive holding the mat/flooring in place but allowing for removal for cleaning, and the crumb-rubber surface providing slip resistance and cushioning for objects placed on the mat/flooring.

8. A method of determining whether a product, generally in sheet form, and comprising: a layer comprising crumb-rubber material, and having a first side and a second side, scrim material bonded to at least one of said first and second sides, and a coating of a pressure sensitive adhesive applied to at least part of an exposed surface of the scrim material, is adapted to allow adjustment in positioning on installation and subsequent removal, the method comprising the steps of:
performing a 90° peel adhesion test at 300 mm/minute, as measured by FINAT Test Method No: 2, after 24 hours adhesive binding dwell-time, the test being performed at room temperature (23° C.±1° C.) and at a relative humidity of 50%±5%; and
determining that the product is suitable if the 90° peel adhesion is between 1.77 and 3.96 Newtons/25 mm width.

9. A method of manufacturing a product, generally in sheet form, allowing adjustment in positioning on installation and subsequent removal, the method comprising the steps of:
bonding crumbs of rubber to each other to form a crumb-rubber layer and to a supporting scrim layer on at least one side of the resulting crumb-rubber layer; and
applying a pressure sensitive adhesive to at least part of the exposed surface of the scrim material,
wherein the adhesive, after 24 hours of adhesive binding dwell-time, has a 90° peel adhesion at 300 mm/minute, as measured by FINAT Test Method No: 2, of between 1.77 and 3.96 Newtons/25 mm width at room temperature (23° C.±1° C.) and at a relative humidity of 50%±5%.
